(19) United States
(12) Patent Application Publication
(10) Pub. No.: US 2007/0040954 A1
(43) Pub. Date: Feb. 22, 2007

(54) Wire structure, a method for fabricating a wire, a thin film transistor substrate, and a method for fabricating the thin film transistor substrate

(75) Inventors: Je-hun Lee, Seoul (KR); Chang-oh Jeong, Suwon-si (KR); Beom-seok Cho, Seoul (KR); Yang-ho Bae, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/440,767

(22) Filed: May 25, 2006

(30) Foreign Application Priority Data
Aug. 16, 2005 (KR) 10-2005-0074834

(51) Int. Cl. G02F 1/136

(52) U.S. Cl. 349/43

(57) ABSTRACT

Provided are a wire structure, a method for fabricating a wire, a thin film transistor (TFT) substrate, and a method for fabricating the TFT substrate. The wire structure includes an underlying layer including a silver oxide formed on a lower structure, and a silver conductive layer including silver or a silver alloy formed on the underlying layer.

### CROSS-REFERENCE TO RELATED APPLICATION

This application claims priority to Korean Patent Application No. 10-2005-0074834, filed on Aug. 16, 2005 in the Korean Intellectual Property Office, the disclosure of which is incorporated by reference herein in its entirety.

### BACKGROUND OF THE INVENTION

1. Technical Field

The present invention relates to a wire structure, and more particularly, to a wire structure containing silver (Ag) or a silver (Ag) alloy, a method for fabricating a wire, a thin film transistor (TFT) substrate, and a method for fabricating the TFT substrate.

2. Discussion of the Related Art

A thin film transistor (TFT) substrate, which includes, for example, a plurality of gate and data lines, pixel electrodes and TFTs, is used as a substrate for a liquid crystal display (LCD) and an organic electroluminescence (EL) display.

For example, a liquid crystal display (LCD), which is one of the most widely used flat panel displays, includes, for example, a TFT substrate, a substrate opposite the TFT substrate and a liquid crystal layer interposed therebetween. In the LCD, the thin film transistors (TFTs) are used as switching elements for controlling picture signals applied to the pixel electrodes.

An organic EL display device, which displays a picture by electrically exciting phosphorescent organic material, includes a TFT substrate that includes a driving TFT for supplying pixels with a current necessary for light emission and a switching TFT.

As the display area of the LCD increases, the length of the gate lines and the data lines connected to the TFTs also increases, thus causing an increase in the resistivity of those wires. To reduce a signal delay resulting from the increased resistivity, the wires forming the gate lines and the data lines should be formed of a material having a low resistivity.

One of the lowest resistivity materials for forming a wire is silver (Ag). For example, silver (Ag) has a resistivity of about 1.59 μΩcm. Thus, by using gate lines and data lines formed of silver (Ag), the signal delay can be reduced. However, silver (Ag) is not easily deposited. Further, the use of silver (Ag) can result in the lifting or peeling of a wire during a subsequent patterning process, thus causing a failure in the wire and degrading the reliability of the wire.

Accordingly, there is a need for a technique of forming a wire by using a low resistivity material such as silver (Ag) whereby the lifting or peeling of the wire can be prevented.

### SUMMARY OF THE INVENTION

According to an aspect of the present invention, there is provided a wire including an underlying layer including silver oxide formed on a lower structure, and a silver conductive layer including silver or a silver alloy formed on the underlying layer.

According to another aspect of the present invention, there is provided a method for fabricating a wire, the method comprising forming an underlying layer including silver oxide on a lower structure, forming a silver conductive layer including silver or a silver alloy on the underlying layer, forming an upper layer on the silver conductive layer, and patterning the upper layer, the silver conductive layer, and the underlying layer using a photoresist pattern defining the wire using an etching mask.

According to still another aspect of the present invention, there is provided a thin film transistor (TFT) substrate including a gate wire formed on an insulating substrate and including a gate line extending in a first direction and a gate electrode connected to the gate line, and a data wire formed on the insulating substrate insulated from the gate wire and including a data line extending in a second direction and intersecting the gate line, a source electrode connected to the data line, and a drain electrode spaced apart from the source electrode on the insulating substrate, wherein the gate wire and the data wire each comprise an underlying layer including silver oxide formed on a lower structure and a silver conductive layer including silver or a silver alloy formed on the underlying layer.

According to a further aspect of the present invention, there is provided a method for fabricating a thin film transistor (TFT) substrate, the method including forming a gate wire on an insulating substrate including a gate line extending in a first direction and a gate electrode connected to the gate line, and forming a data wire on the insulating substrate insulated from the gate wire and including a data line extending in a second direction and intersecting the gate line, a source electrode connected to the data line, and a drain electrode spaced apart from the source electrode on the insulating substrate, wherein forming each of the gate wire and the data wire comprises: forming an underlying layer including silver oxide on a lower structure; forming a silver conductive layer including silver or a silver alloy on the underlying layer, forming an upper layer on the silver conductive layer, and patterning the upper layer, the silver conductive layer and the underlying layer using a photoresist pattern defining the wire as an etching mask.

### BRIEF DESCRIPTION OF THE DRAWINGS

The above and other features of the present invention will become more apparent by describing in detail exemplary embodiments thereof with reference to the attached drawings in which:

FIG. 1 is a sectional view showing a wire structure according to an exemplary embodiment of the present invention;

FIGS. 2 and 3 are sectional views illustrating a method for fabricating a wire according to an exemplary embodiment of the present invention;

FIG. 4 is a plan view of a wire structure according to an exemplary embodiment of the present invention;

FIG. 5A is a layout view of a thin film transistor (TFT) substrate according to an exemplary embodiment of the present invention;

FIG. 5B is a sectional view taken along a line B-B′ of FIG. 5A;

FIGS. 6A, 8A, 9A and 10A are layout views showing a method for fabricating a TFT substrate according to an exemplary embodiment of the present invention;

FIGS. 6B and & are sectional views taken along a line B-B′ of of FIG. 6A;

FIGS. 8B, 9B and 10B are sectional views taken along lines B-B′ of FIGS. 8A, 9A and 10A, respectively;

FIG. 11A is a layout view of of a TFT substrate according to another exemplary embodiment of the present invention;

FIG. 11B is a sectional view taken along a line B-B′ of FIG. 11A;

FIG. 12A is a layout view of a TFT substrate according to another exemplary embodiment of the present invention;

FIGS. 12B and 12C are sectional views taken along lines B-B′ and C-C′ of FIG. 12A;

FIGS. 13A, 14A, 15A, 16A, 17A, and 18A are layout views showing a method for fabricating a TFT substrate according to another exemplary embodiment of the present invention;

FIGS. 13B, 14B, 15B, 16B, 17B, and 18B are sectional views taken along lines B-B′ of FIGS. 13A, 14A, 15A, 16A, 17A, and 18A, respectively; and

FIGS. 13C, 14C, 15C, 16C, 17C, and 18C are sectional views taken along lines C-C′ of FIGS. 13A, 14A, 15A, 16A, 17A, and 18A, respectively.

### DETAILED DESCRIPTION OF EXEMPLARY EMBODIMENTS

Exemplary embodiment of the present invention will now be described more fully hereinafter with reference to the accompanying drawings.

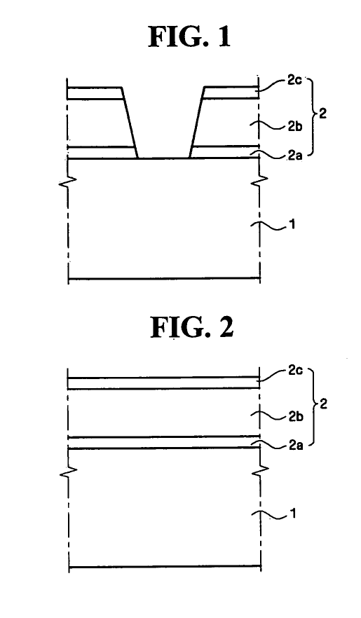

Hereinafter, a wire structure and a method for fabricating a wire according to an embodiment of the present invention will be described with reference to the accompanying drawings. FIG. 1 is a sectional view showing a wire structure according to an embodiment of the present invention.

Referring to FIG. 1, an underlying layer 2a including a silver (Ag) oxide is interposed between a lower structure 1 and a silver conductive layer 2b. An upper layer 2c is formed on the silver conductive layer 2b.

The lower substrate 1 provides a surface where a wire 2 is formed and supports the wire 2. The lower structure 1 may be a single structure having a single component, element, layer or the like, or a complex structure having a combination of multiple components, elements, layers or the like. The lower structure 1 may be, for example, an insulating substrate made of glass, a semiconductor layer made of amorphous silicon, or an insulating layer, but is not limited thereto.

The silver conductive layer 2b including silver (Ag) or a silver (Ag) alloy is formed on the lower structure 1. Since silver (Ag) exhibits a low resistivity, e.g., about 2.1 μΩcm, in a thin film state, it is preferably used as a wiring material. The thickness of the silver conductive layer 2b may be larger than about 500 Å for providing stability to a wire pattern and smaller than about 5000 Å for providing a low resistivity and a thin film characteristic.

The underlying layer 2a is positioned between the lower structure 1 and the silver conductive layer 2b. The underlying layer 2a includes a silver oxide such as AgO or Ag₂O. The underlying layer 2a increases adhesion between the lower substrate 1 and the silver conductive layer 2b. The principle of how the underlying layer 2a increases adhesion between the lower substrate 1 and the silver conductive layer 2b will now be described.

It is assumed that the lower structure 1 is made of glass. In this case, the glass contains amorphous SiO₂ as a main component and has silicon (Si) and oxygen (O) combined with each other. At this time, the silicon (Si) and oxygen (O) forming the glass are not stabilized. In other words, the outermost electrons thereof are not all filled with elements, while some of the outermost electrons form dangling bonds that are not combined with other elements. The oxygen dangling bonds are presumably associated with binding to metal films.

In other words, adhesion between glass and a metallic material is mainly derived from bonds between glass-oxygen dangling bonds and the metallic material. Thus, the extent of adhesion of glass to the metallic material depends upon the binding force of the oxygen dangling bonds existing on the glass surface and the metallic material. The binding force of the oxygen dangling bonds existing on the glass surface and the metallic material is substantially proportional to a free energy value of forming an oxide of the metallic material.

Here, free energy values of several exemplary wiring materials are as follows. For example, the free energy value of Al₂O₃ is −1580 kJ/mol, the free energy value of Cu₂O is −297 kJ/mol, and the free energy value of Ag₂O is −11 kJ/mol. In other words, the free energy value of Ag₂O is much higher than that of Al₂O₃ or Cu₂O. Therefore, the adhesion between silver (Ag) and glass is much smaller than that between aluminum (Al) and glass so that silver (Ag) is not easily adhered to glass.

To facilitate the adhesion between silver (Ag) and glass, the underlying layer 2a includes silver oxide. Then, oxygen dangling bonds derived from silver oxide are formed on the bottom of the underlying layer 2a, forming an interface with the glass, and are thus capable of being combined with oxygen dangling bonds derived from the glass. At this time, since the free energy value of O₂ is much smaller than that of Ag₂O, the oxygen dangling bonds of silver oxide and glass can be easily combined, thus facilitating adhesion between silver (Ag) and glass. In addition, the oxygen dangling bonds originating from silver oxide can be easily combined with silicon dangling bonds originating from glass, thereby further increasing adhesion.

Since the underlying layer 2a including silver nitride has a large amount of silver, adhesion between the underlying layer 2a and the silver conductive layer 2b thereon is superior as compared to adhesion between the lower structure 1 and the silver conductive layer 2b.

In the foregoing description, the lower structure 1 has been described as being made of glass; however, the lower structure 1 may be a semiconductor layer made of amorphous silicon. In this case, silicon dangling bonds may exist at an interface between the semiconductor layer and the underlying layer 2a. Since the silicon dangling bonds and the oxygen dangling bonds originating from silver oxide of the underlying layer 2a are easily combined with each other, the adhesion therebetween can be enhanced.

Further, even when the lower structure 1 is an insulating layer made of SiNx, the adhesion can be improved by using the underlying layer 2a including silver oxide.

The underlying layer 2a may include other materials, e.g., silver (Ag) or a silver (Ag) alloy, in addition to silver oxide. In this case, to exhibit sufficient adhesion, the amount of silver oxide is adjusted. For example, the amount of the silver oxide in the underlying layer 2a may be at least about 5 at % when expressed by the atomic percent of oxygen based on all atoms in the underlying layer 2a.

When sufficient adhesion and electric conductivity are both considered, the content of oxygen relative to the elements of the underlying layer 2a may be not greater than 60 at %. If the content of oxygen is not greater than 60 at %, in other words, if the underlying layer 2a exhibits low resistivity, e.g., about 68.01 μΩcm, electric conductivity is not a critical factor even when the lower structure 1 is a semiconductor layer.

The underlying layer 2a may also include at least one atomic layer and its thickness may be larger than about 10 Å. For a low resistivity, the thickness of the underlying layer 2a may be smaller than about 2000 Å. It is preferable, however, that silver oxide included in the underlying layer 2a be positioned at an interface between the lower structure 1 and the underlying layer 2a.

According to a formation method, the underlying layer 2a may include silver (Ag) or a silver (Ag) alloy. When the underlying layer 2a and the silver conductive layer 2b are continuously disposed thereon, a boundary therebetween may be unclear. In this case, a silver content may be considered as one criterion for making the boundary between the underlying layer 2a and the silver conductive layer 2b clear. In other words, since high electric conductivity can be indicated even by a trace of silver oxide, the trace of silver oxide may be included in the silver conductive layer 2b. Further, although an amount of silver oxide in the underlying layer 2a may be less than an amount of silver oxide in the silver conductive layer 2b, it may still be used to improve adhesion therebetween. In other words, the distribution of silver oxide does not have to be continuous. Rather, it is preferable that a large amount of silver oxide be distributed around the interface between the underlying layer 2a and the lower structure 1. In addition, it is preferable that silver oxide be continuously distributed to as many locations as possible.

To protect the silver conductive layer 2b from being attacked by a chemical substance or a reactive gas during an etching process, the wire 2 may further include the upper layer 2c, e.g., a capping layer, on the silver conductive layer 2b. For processing simplicity, the upper layer 2c may comprise silver (Ag) or a silver (Ag) alloy, like the underlying layer 2a. The upper layer 2c may be formed to a thickness of about 10 to about 2000 Å. The upper layer 2c is made of an oxide such as indium tin oxide (ITO) or amorphous ITO, indium zinc oxide (IZO), metal such as tungsten (W), molybdenum (Mo), molybdenum-niobium (MoNi) alloy or a molybdenum-tungsten (MoW) alloy, or the like. Formation of the upper layer 2c may be omitted according to a subsequent process or a chemical substance used. When necessary, another layer may be interposed between the silver conductive layer 2b and the underlying layer 2a or between the silver conductive layer 2b and the upper layer 2c. In addition, the wire 2 may have a multi-layered structure having another layer provided on the upper layer 2c.

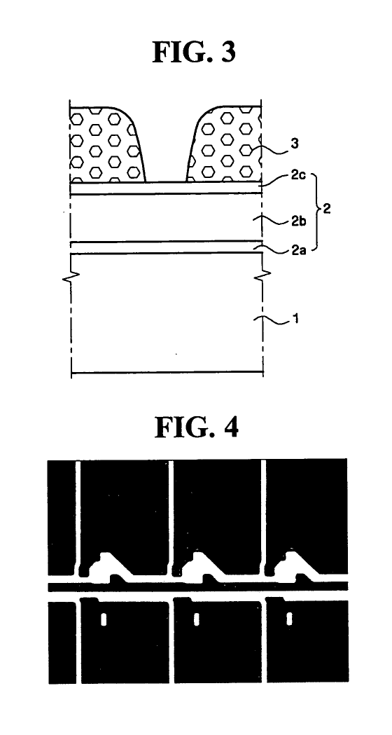

Next, a method for fabricating a wire having the above-described structure will be described with reference to FIGS. 1 through 4. FIGS. 2 and 3 are sectional views illustrating processing steps of a method for fabricating a wire according to an embodiment of the present invention.

Referring to FIG. 2, the lower structure 1 including an insulating substrate (e.g., glass), a semiconductor layer, and an insulating layer is prepared. Next, reactive sputtering is performed on the lower structure 1 in an atmosphere including a gas, e.g., oxygen, using silver (Ag) or a silver (Ag) alloy as a target. Here, the gas used for the sputtering may also include argon (Ar) in addition to oxygen. When the argon (Ar) gas, which is an inactive gas, collides with silver (Ag) as a target in a plasma state, it is separated from the target to then be deposited on the lower structure 1. Since the oxygen gas has reactivity, silver (Ag), which has collided with the oxygen gas, may react with oxygen to then form silver oxide, which is deposited on the lower structure 1, thereby contributing to improved adhesion. In this case, all target elements do not react with oxygen gas. Thus, silver (Ag) atoms which have collided with argon (Ar) gas and silver (Ag) atoms which have collided with oxygen gas but have not reacted with it, together with silver oxide, constitute the underlying layer 2a.

Argon gas and oxygen gas contained in a sputtering chamber may have a ratio of 95:5˜40:60. Preferably, an amount of oxygen is maintained at a high level in an initial sputtering stage and is gradually reduced. In contrast, an amount of argon is gradually increased. Then, silver oxide can be concentrated in the vicinity of the interface between the lower structure 1 and the underlying layer 2a. The amount of oxygen contained in the underlying layer 2a may be in a range of about 5 to about 60 at %. A thickness of the underlying layer 2a can be adjusted to be in a range of about 10 to about 2000 Å.

Next, silver (Ag) or a silver (Ag) alloy is deposited on the underlying layer 2a by sputtering to form the silver conductive layer 2b. The sputtering is performed in situ continuously from the previous step, that is, the step of forming the underlying layer 2a, while supplying argon (Ar) gas with an induced amount of oxygen gas interrupted in the same chamber. In addition, to make a boundary between the underlying layer 2a and the silver conductive layer 2b clear, the sputtering may be performed on the silver conductive layer 2b with an induced amount of oxygen gas entirely removed within a short purge period after the supply of the oxygen gas is interrupted. Here, a thickness of the silver conductive layer 2b may be in a range of about 500 to about 5000 Å.

Next, reactive sputtering is performed using silver (Ag) or a silver (Ag) alloy as a target while supplying oxygen again. The reactive sputtering is performed in situ continuously from the previous step, that is, the step of forming the silver conductive layer 2b. In this way, the upper layer 2c containing silver oxide is formed on the silver conductive layer 2b. Then, a triple-layered wire 2 consisting of the underlying layer 2a, the silver conductive layer 2b, and the upper layer 2c is formed. In the illustrated embodiment, since the triple-layered wire 2 is formed continuously in a single chamber, a processing time thereof can be reduced. It is to be understood by those skilled in the art that when ITO, IZO, or other metallic materials in addition to silver oxide are used for the upper layer 2c, sputtering or reactive sputtering may be performed using different targets in different atmospheres.

Referring to FIG. 3, a photoresist layer (not shown) is coated on the triple-layered wire 2 and is exposed and developed, thereby forming a photoresist pattern 3 defining a wire.

Next, as shown in FIG. 1, the upper layer 2c, the silver conductive layer 2b, and the underlying layer 2a are sequentially etched using the photoresist pattern 3 as an etching mask. Here, the etching may be performed by wet etching. The triple-layered wire 2 may be etched in a batch process using the same etchant. Phosphoric acid, nitric acid and acetic acid may be included in the etchant. Then, the photoresist pattern 3 is removed. Thus, the wire 2 shown in FIG. 1 is completed.

The adhesion of the thus-formed wire 2 was verified by micro photography. FIG. 4 is a plan view of the wire structure according to an embodiment of the present invention. Referring to FIG. 4, the wire 2 has a triple-layered structure including a lower layer made of silver oxide, a silver conductive layer containing silver (Ag), and an upper layer containing IZO with an amount of oxygen of the lower layer being approximately 20 at %. Here, after etching is performed for 40 seconds using an etchant including phosphoric acid, nitric acid, and acetic acid, the photoresist layer is removed while ultrasonic waves are applied. In FIG. 4, a relatively bright region indicates a wire region.

As shown in FIG. 4, a clear wire pattern is obtained, so that linearity is ensured even after patterning such as wet etching or removing photoresist, and a wire, which includes a silver conductive layer, is well adhered to a lower structure. In other words, the wire exhibits a superior signal characteristic as a low-resistivity wire, and good adhesion, thus providing for its high reliability.

The above-described wire structure and the fabrication method thereof can be applied to a TFT substrate for an LCD or an organic EL display, a semiconductor device, a semiconductor apparatus, and any other devices or areas necessitating precise wiring patterns. In the embodiments described below, while the present invention will be described with regard to a TFT substrate, it is to be understood by those skilled in the art that the invention is not limited thereto.

Further, the term “thin film transistor” as used herein refers to at least one TFT on a substrate but does not preclude the intervention of another structure between the TFT and the substrate or the presence of an additional structure formed thereon.

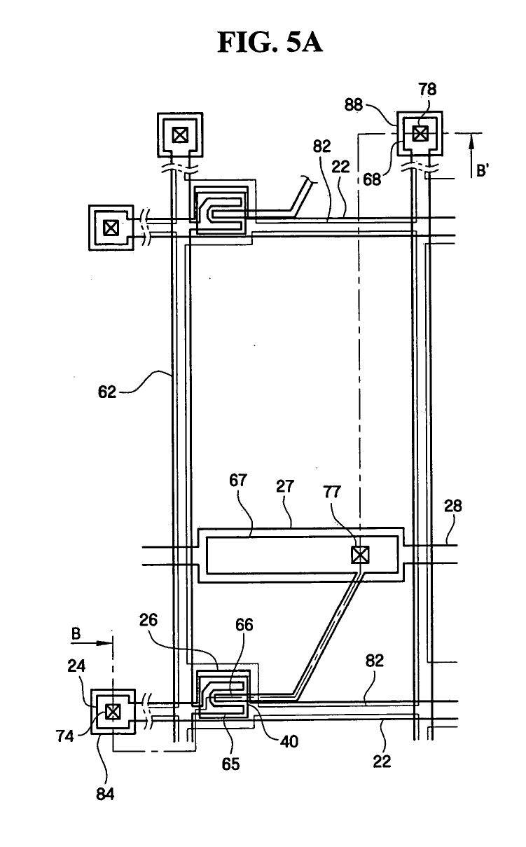

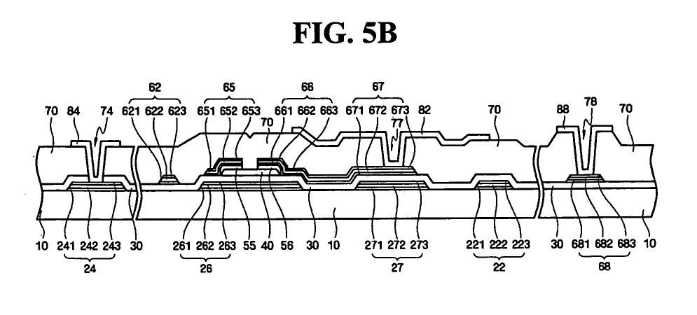

A thin film transistor (TFT) substrate according to an embodiment of the present invention including the wire structure of FIG. 1 will be described with reference to FIGS. 5A and 5B. FIG. 5A is a layout view of a thin film transistor (TFT) substrate according to an embodiment of the present invention, and FIG. 5B is a sectional view taken along a line B-B′ of FIG. 5A.

As shown in FIGS. 5A and 5B, a plurality of gate wires for transmitting a gate signal is formed on an insulating substrate 10. A gate wire (22, 24, 26, 27, 28) includes a gate line 22 that extends in a transverse direction, a gate line pad 24 that is connected to the end of the gate line 22 to receive a gate signal from external circuits and transmit the same to the gate line 22, a gate electrode 26 of a protruding TFT that is connected to the gate line 22, and a storage electrode 27 and a storage electrode line 28 formed in parallel with the gate line 22. The storage electrode line 28 extends in a transverse direction across a pixel region and is connected to the storage electrode 27 that is wider than the storage electrode line 28. The storage electrode 27 overlaps a drain electrode extension portion 67 connected with a pixel electrode 82, which will be described later, and forms a storage capacitor that enhances a charge storage capacity of a pixel. The shape and arrangement of the storage electrode line 28 and the storage electrode 27 may vary. When a storage capacitor generated by overlapping the pixel electrode 82 and the gate line 22 is sufficient, the formation of the storage electrode 27 may be omitted.

As shown in FIG. 5B, the gate wire (22, 24, 26, 27) has a triple-layered structure including silver oxide, a conductive layer (222, 242, 262, 272) containing silver (Ag) or a silver (Ag) alloy, and an upper layer (223, 243, 263, 273), respectively. Although not shown in FIG. 5B, the storage electrode line 28 has the same multi-layered structure as the gate wire (22, 24, 26, 27). The storage electrode line 28 is also included in a gate wire having a multi-layered structure, which will be described below, and characteristics of the gate wire (22, 24, 26, 27) hold true for the storage electrode line 28. The wire structure of FIG. 1 is applied to the multi-layered gate wire (22, 24, 26, 27, 28).

A gate insulating layer 30 is formed of silicon nitride (SiNx) on the substrate 10 and the gate wire (22, 24, 26, 27, 28). Here, an underlying layer (221, 241, 261, 271) assists with adhesion of the overlying silver (Ag) conductive layer (222, 242, 262, 272) to the insulating substrate 10 while the upper layer (223, 243, 263, 273) prevents the silver (Ag) conductive layer (222, 242, 262, 272) from being damaged during a subsequent step.

A semiconductor layer 40 is formed of hydrogenated amorphous silicon or polycrystalline silicon in the shape of an island on the gate insulating layer 30 on the gate electrode 26. Ohmic contact layers 55 and 56 are formed on the semiconductor layer 40 and may be made of silicide or n+ hydrogenated amorphous silicon doped with a high concentration n-type impurity.

A data wire (62, 65, 66, 67, 68) is formed on the ohmic contact layers 55 and 56 and the gate insulating layer 30. The data wire (62, 65, 66, 67, 68) includes a data line 62 substantially extending in a longitudinal direction and intersecting the gate line 22 to define a pixel, a source electrode 65 connected to the data line 62 and extending over the ohmic contact layer 55, a data line pad 68 connected to an end of the data line 62 and receiving a picture signal from external circuits, a drain electrode 66 spaced apart from the source electrode 65 and formed on the ohmic contact layer 56 to be opposite the source electrode 65 in view of the gate electrode 26, and a drain electrode extension portion 67 extending from the drain electrode 66 and having a large area overlapping the storage electrode 27.

Like the gate wire (22, 24, 26, 27), the data wire (62, 62, 66, 67, 68) is formed of a triple-layered structure including an underlying layer (621, 651, 661, 671, 681) containing silver oxide, a silver conductive layer (622, 652, 662, 672, 682) containing silver (Ag) or a silver (Ag) alloy, and an upper layer (623, 653, 663, 673, 683), respectively. The wire structure of FIG. 1 is applied to the thus-formed multi-layered data wire (62, 65, 66, 67, 68). In other words, the underlying layer (621, 651, 661, 671, 681) complements adhesion of the silver conductive layer (622, 652, 662, 672, 682) to a lower structure, that is, the ohmic contact layers 55 and 56 and the gate insulating layer 30.

The source electrode 65 overlaps at least a portion of the semiconductor layer 40. The drain electrode 66 is opposed to and faces the source electrode 65 in view of the gate electrode 26 and overlaps at least a portion of the semiconductor layer 40.

The drain electrode extension portion 67 overlaps the storage electrode 27 to form a storage capacitor between the storage electrode 27 and the gate insulating layer 30. In the absence of the storage electrode 27, the drain electrode extension portion 67 may not be formed.

Here, the gate electrode 26, the semiconductor layer 40 formed thereon, the ohmic contact layers 55 and 56, the source electrode 65, and the drain electrode 66 constitute a TFT and the semiconductor layer 40 constitutes a channel portion of the TFT. In the illustrated embodiment, a bottom gate-type TFT where the gate electrode 26 is formed under the semiconductor layer 40 including the channel portion is adopted.

A passivation layer 70 is formed on the data lines 62, 65, 66, 67, 68, and exposes a portion of the semiconductor layer 40 therethrough. The passivation layer 70 is preferably made of a photosensitive organic material having a good flatness characteristic, a low dielectric insulating material such as a-Si:C:O and a-Si:O:F formed by plasma enhanced chemical vapor deposition (PECVD), or an inorganic insulator such as silicon nitride. When the passivation layer 70 is made of an organic material, an insulation layer (not shown) made of silicon nitride (SiN) or silicon oxide (SiO₂) may further be provided under the organic layer to prevent an organic material of the passivation layer 70 from contacting an exposed portion of the semiconductor layer 40 between the source electrode 65 and the drain electrode 66.

Contact holes 77 and 78 are formed in the passivation layer 70 to expose the drain electrode extension portion 67 and the data line pad 68, respectively. A contact hole 74 is formed in the passivation layer 70 and the gate insulating layer 30 to expose the gate line pad 24. The pixel electrode 82 is formed on the passivation layer 70 to be electrically connected to the drain electrode 66 via the contact hole 77 and is positioned in a pixel area. The pixel electrode 82 receives data voltages from the drain electrode 66, and electric fields are generated between the pixel electrode 82 supplied with the data voltages and a common electrode of an upper display substrate, which determine an orientation of liquid crystal molecules in an LC layer between the pixel electrode 82 and the common electrode.

Further, an auxiliary gate line pad 84 and an auxiliary data line pad 88 are formed on the passivation layer 70 to be connected to the gate line pad 24 and the data line pad 68 via the contact holes 74 and 78, respectively. The pixel electrode 82 and the auxiliary gate line pad 86 and the auxiliary data line pad 88 are preferably made of a transparent conductor such as ITO.

The TFT substrate of FIGS. 5A and 5B can be applied to a liquid crystal display (LCD) device.

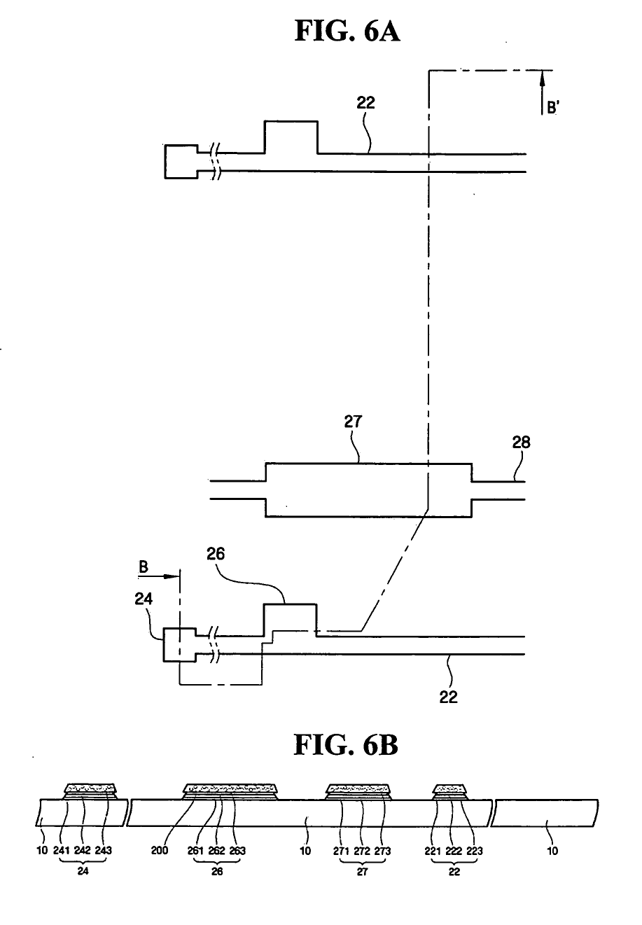

Next, a method for fabricating the TFT substrate of FIGS. 5A and 5B according to an embodiment of the present invention will be described in detail with reference to FIGS. 6A through 9B.

First, as shown in FIGS. 6A, 6B and 7, a multi-layered gate layer is formed by sequentially depositing the underlying layer (221, 241, 261, 271) containing silver oxide, the silver conductive layer (222, 242, 262, 272) containing silver (Ag) or a silver (Ag) alloy, and the upper layer (223, 243, 263, 273) on the insulating substrate 10 by sputtering. Next, a photoresist pattern defining the gate wire (22, 24, 26, 27, 28) is formed on the multi-layered gate layer, and the upper layer (223, 243, 263, 273), the silver conductive layer (222, 242, 262, 272) and the upper layer (223, 243, 263, 273) are sequentially etched or etched in a batch process using the photoresist pattern as an etching mask. The photoresist pattern is then removed. Thus, the gate wire including the gate line 22, the gate electrode 26, the gate line pad 24, the storage electrode 27, and the storage electrode line 28 are formed by the same method used for forming the wire structure of FIG. 1. The gate wire (22, 24, 26, 27, 28) is completed. Thus, the completed gate wire (22, 24, 26, 27, 28) including the silver conductive layer (222, 242, 262, 272) can be well adhered to a lower structure, e.g., the insulating substrate 10, even after wet etching and removing photoresist, as described in FIG. 4.

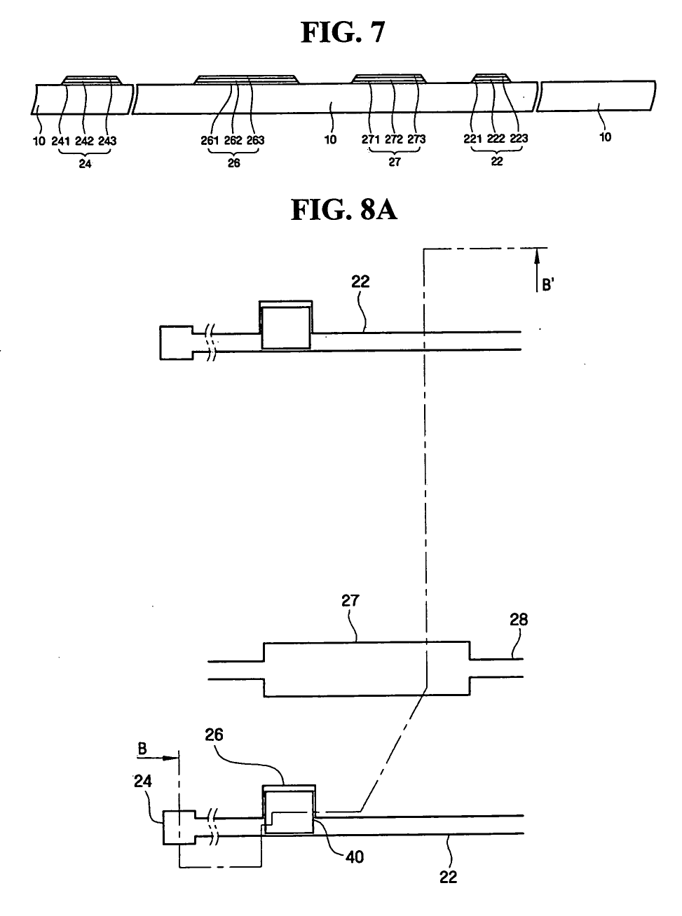

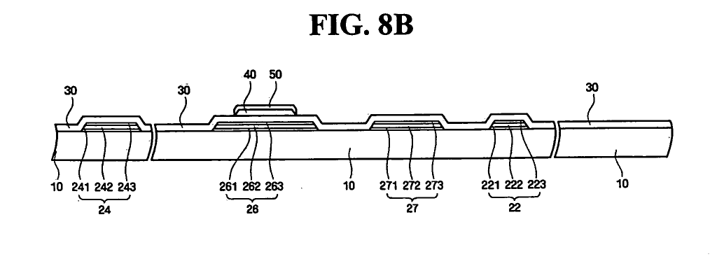

Next, as shown in FIGS. 8A and 8B, the gate insulating layer 30 made of silicon nitride, an intrinsic amorphous silicon layer, and a doped amorphous silicon layer are continuously deposited to a thickness of about 1500-about 5000 Å, a thickness of about 500-about 2000 Å, and a thickness of about 300-about 600 Å, respectively, using chemical vapor deposition (CVD). The intrinsic amorphous silicon layer and the doped amorphous silicon layer are etched using photolithography to form an island-shaped semiconductor layer 40 and a doped amorphous silicon layer 50 on a portion of the gate insulating layer 30 corresponding to the gate electrode 26.

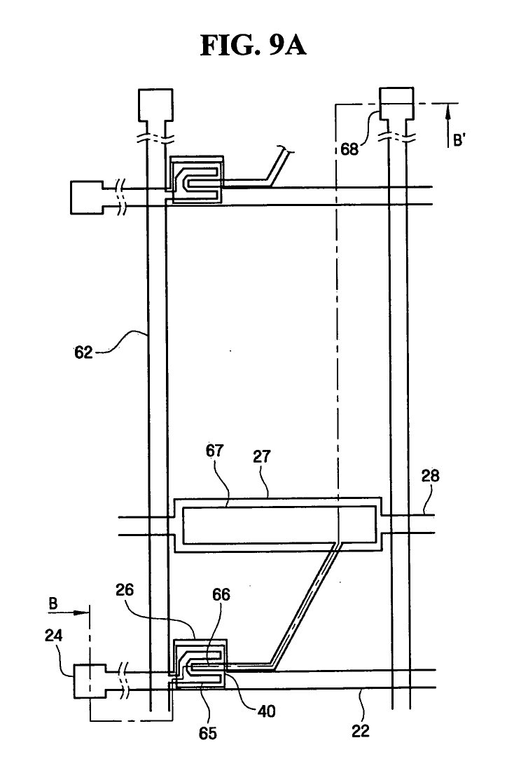

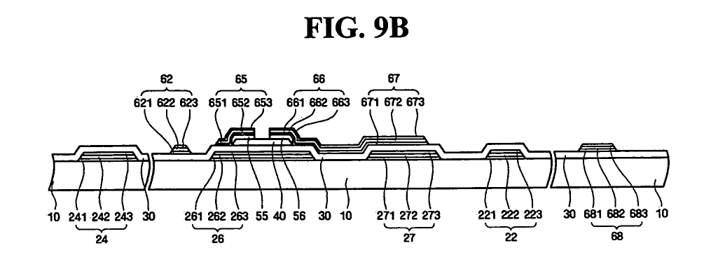

Next, as shown in FIGS. 9A and 9B, a multi-layered data layer is formed by sequentially depositing the underlying layer (621, 651, 661, 671, 681) containing silver oxide, the silver conductive layer (622, 652, 662, 672, 682) containing silver or a silver alloy, and the upper layer (623, 653, 663, 673, 683) on the gate insulating layer 30 and the doped amorphous silicon layer 50 by sputtering. A photoresist pattern defining the data wire (62, 65, 66, 67, 68) is formed on the multi-layered data layer and the upper layer (623, 653, 663, 673, 683), the silver conductive layer (622, 652, 662, 672, 682), and the underlying layer (621, 651, 661, 671, 681) are sequentially etched or etched in a batch process using the photoresist pattern as an etching mask, thereby exposing the doped amorphous silicon layer 50 under a channel portion. The photoresist pattern is removed. The data wire (62, 65, 66, 67, 68) is formed, the data wire (62, 65, 66, 67, 68) including the data line 62 substantially extending in a longitudinal direction and intersecting the gate line 22, the source electrode 65 connected to the data line 62 and extending over the ohmic contact layer 55, the data line pad 68 connected to an end of the data line 62 and receiving a picture signal from external circuits, the drain electrode 66 spaced apart from the source electrode 65 and formed on the ohmic contact layer 56 to be opposite the source electrode 65 in view of the gate electrode 26, and the drain electrode extension portion 67 extending from the drain electrode 66 and having a large area overlapping the storage electrode 27. The data wire (62, 65, 66, 67, 68) is formed by the same method for forming the wire structure of FIG. 1. Thus, as described above with reference to FIG. 4, the formed data wire (62, 65, 66, 67, 68) is well adhered to a lower structure, e.g., the insulating substrate 10, even after wet etching and removing photoresist.

Next, dry etching is performed on the doped amorphous silicon layer 50 not covered by the data wire (62, 65, 66, 67, 68), thereby forming the ohmic contact layers 55 and 56 at both sides in view of the gate electrode 26 and exposing the semiconductor layer 40 between the ohmic contact layers 55 and 56. At this time, the etching may be performed using the source electrode 65 and drain electrode 66 as etching masks and the photoresist pattern defining the data wire (62, 65, 66, 67, 68) may be removed after dry etching is performed on the doped semiconductor layer 40 using the photoresist pattern defining the data wire (62, 65, 66, 67, 68) as an etching mask. Thus, a bottom gate-type TFT is formed, including the gate electrode 26, the semiconductor layer 40 formed thereon, the ohmic contact layers 55 and 56, the source electrode 65, and the drain electrode 66 in which the gate electrode 26 is formed under the channel portion of the semiconductor layer 40.

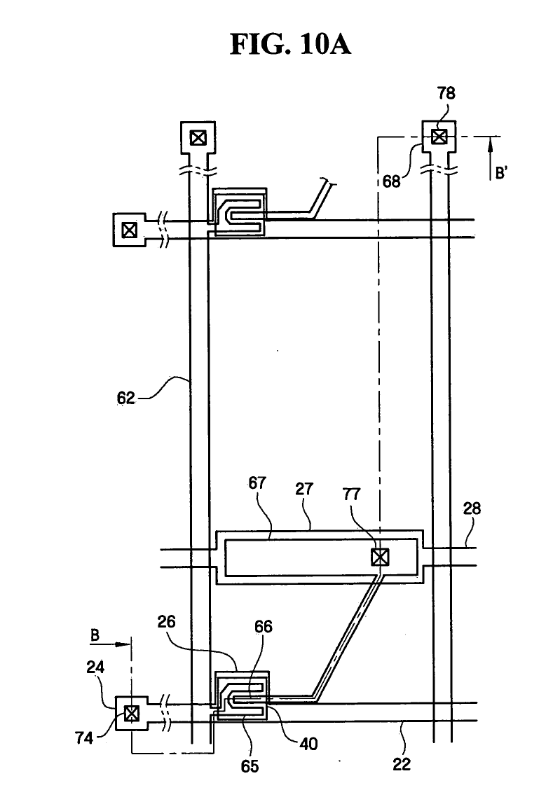

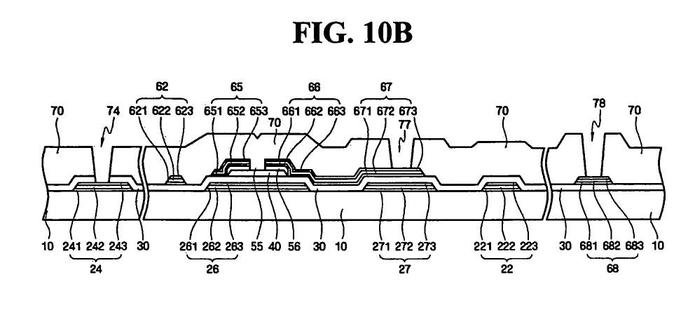

Next, as shown in FIGS. 10A and 10B, the passivation layer 70 is formed of a single layer or multi-layers made of an organic material having superior flatness properties and photosensitivity, an insulating material having a low dielectric constant formed by plasma enhanced chemical vapor deposition (PECVD), such as a-Si:C:O or a-Si:O:F, or an inorganic material such as SiNx.

Next, the gate insulating layer 30 and the passivation layer 70 are patterned by photolithography, thereby forming the contact holes 74, 77, and 78 exposing the gate line pad 24, the drain electrode extension portion 67, and the data line pad 68. When the passivation layer 70 is made of an organic photoresist, the contact holes 74, 77, and 78 can be formed just by photolithography.

Referring back to FIGS. SA and SB, a transparent conductive material such as ITO or IZO or a material having superior reflectivity such as aluminum (Al) or an aluminum (Al) alloy or silver (Ag) or a silver (Ag) alloy is deposited and photolithography is performed on the ITO layer, thereby forming the pixel electrode 82 connected to the drain electrode 66 through the contact hole 77 and the auxiliary gate line pad 84 and the auxiliary data line pad 88 connected to the gate line pad 24 and the data line pad 68 through the contact holes 74 and 78.

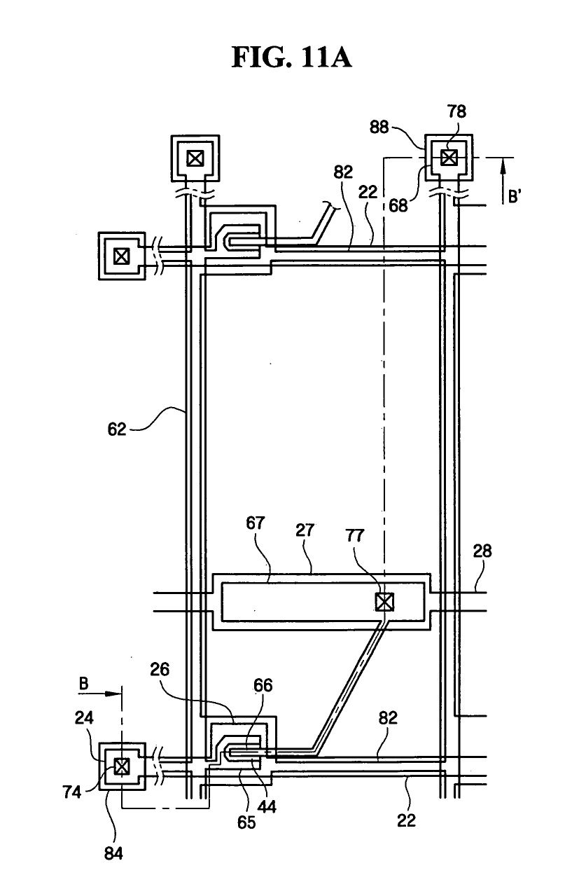

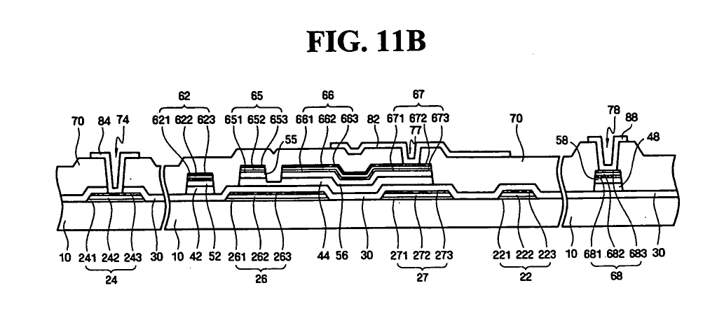

A TFT substrate having a semiconductor layer and wires whose patterns are the same and a method for fabricating the TFT substrate will now be described with reference to FIGS. 11A and 11B. FIG. 11A is a circuit diagram of a TFT substrate according to another embodiment of the present invention, and FIG. 11B is a sectional view taken along a line B-B′ of FIG. 11A.

As shown in FIGS. 11A and 11B, the TFT substrate has a similar structure as the TFT substrate in FIGS. 5A and SB except that semiconductor layer 44 and ohmic contact layers 52, 55, 56, and 68 are formed in a linear shape having the same pattern as the data wire (62, 65, 66, 67, 68). The ohmic contact layers 52, 55, 56, and 68 substantially have the same patterns as the data wire (62, 65, 66, 67, 68) but are different in that the semiconductor layer 44 is not disconnected at the channel portion. Unlike the fabrication method of the TFT substrate of FIGS. 5A and 5B in which different masks are used to form a semiconductor layer and data wire, in the fabrication method of the TFT substrate of FIGS. 11A and 11B, a data wire, ohmic contact layers, and a data line are patterned using a single mask including a slit or semi-permeable membrane. Since the other processes are substantially the same as those of the fabrication method of the TFT substrate of FIGS. 5A and 5B, a detailed description will not be given.

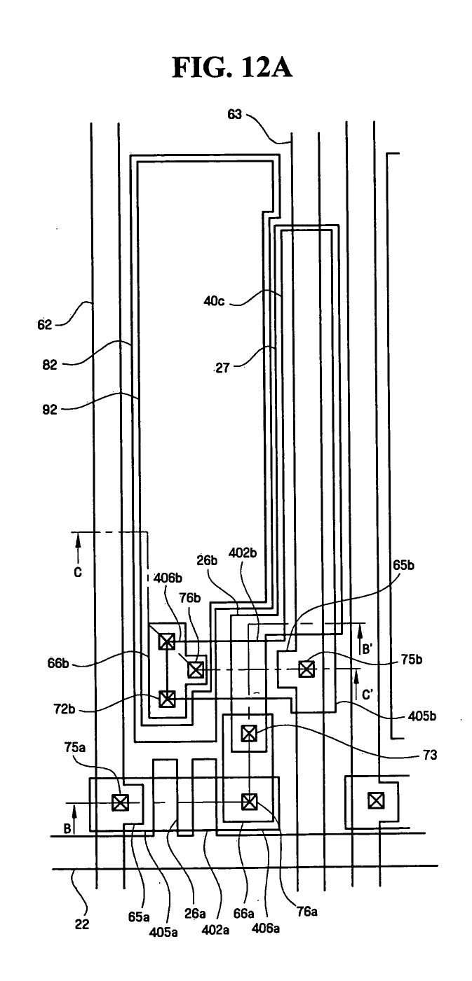

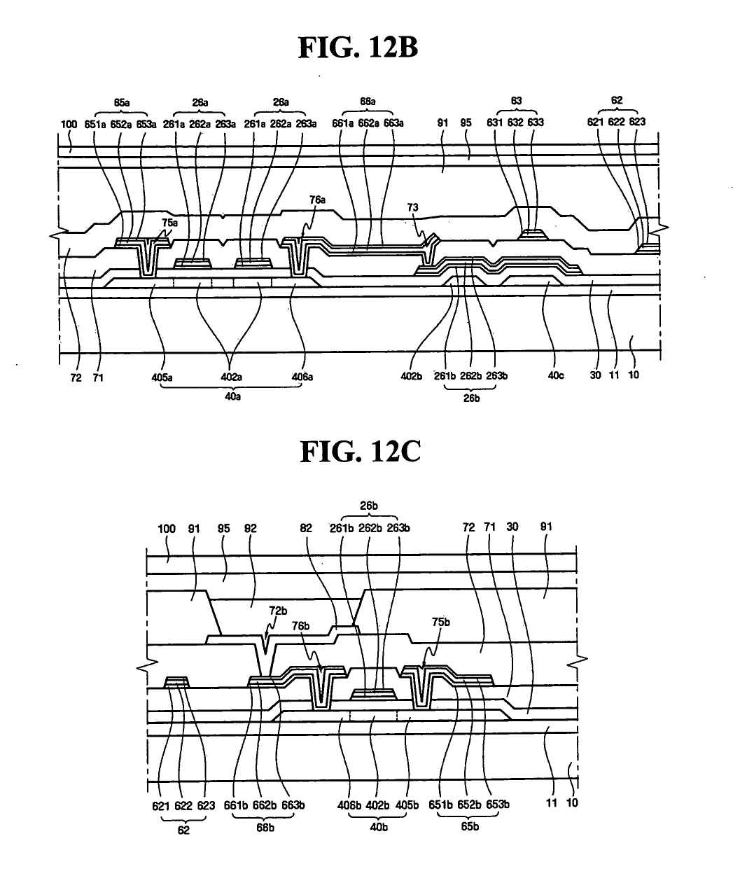

Next, a method for fabricating a TFT substrate according to another embodiment of the present invention will be described with reference to FIGS. 12A through 12C. The TFT substrate of FIGS. 12A through 12C is used for organic EL display devices and includes the wire structure of FIG. 1. FIG. 12A is a circuit diagram of a TFT substrate according to another embodiment of the present invention, and FIGS. 12B and 12C are sectional views taken along lines B-B′ and C-C′ of FIG. 12A.

As shown in FIGS. 12A through 12C, a blocking layer 11 made of silicon oxide or silicon nitride is formed on an insulating substrate 10 and a first semiconductor layer 40a and a second semiconductor layer 40b made of polycrystalline silicon are formed on the blocking layer 11. A capacitor semiconductor layer 40c made of polycrystalline silicon is connected to the second semiconductor layer 40b. The first semiconductor layer 40a includes first TFT portions 405a, 406a, and 402a and the second semiconductor layer 40b includes second TFT portions 405b, 406b, and 402b. The TFT portion 405a, which is to be referred to as a first source region, and the TFT portion 406a, which is to be referred to as a first drain region, are doped with n-type impurities, and the TFT portion 405b, which is to be referred to as a second source region, and the TFT portion 406b, which is to be referred to as a second drain region, are doped with p-type impurities. According to driving conditions, the first source and drain regions 405a and 406a may be doped with p-type impurities and the second source and drain regions 405b and 406b may be doped with n-type impurities.

A gate insulating layer 30 made of silicon oxide or silicon nitride is formed on the semiconductor layers 40a, 40b, and 40c.

A gate wire (22, 26a, 26b, 27) is formed on the gate insulating layer 30, including a gate line 22 extending in a transverse direction, a first gate electrode 26a connected to the gate line 22 in the form of a protrusion and overlapping the channel portion 402a of a first TFT, a second gate electrode 26b spaced apart from the gate line 22 and overlapping the channel portion 402b of a second TFT, and a storage electrode 27 (not shown) connected to the second gate electrode 26b and overlapping the capacitor semiconductor layer 40c. Although the storage electrode 27 is not shown in FIGS. 12A through 12C, it is to be understood that the storage electrode 27 is the same as or similar to the storage electrode 27 shown in FIGS. 5A and 5B.

The gate wire (22, 26a, 26b, 27) has a triple-layered structure including an underlying layer (261a, 261b, 271) containing silver oxide, a silver conductive layer (262a, 262b, 272) containing silver (Ag) or a silver (Ag) alloy, and an upper layer (263a, 263b, 273). Although not shown in FIGS. 12B and 12C, the gate line 22 has the same multi-layered structure as the gate wire (26a, 26b, 27), which will be described in detail below, and characteristics of the gate wire (26a, 26b, 27) hold true for the gate line 22.

The wire structure of FIG. 1 can be applied to the multi-layered gate wire (22, 26a, 26b, 27). For example, here, the underlying layer (261a, 261b, 271) assists with adhesion between the overlying conductive layer (262a, 262b, 272) and the gate insulation layer 30 and prevents materials forming the insulating substrate 10 and the silver conductive layer (262a, 262b, 272) from being diffused into each other.

A first interlayer insulating layer 71 is formed on the gate insulating layer 30 where the gate wire (22, 26a, 26b, 27) is formed.

A data wire (62, 63, 65a, 65b, 66a, 66b) is formed on the first interlayer insulating layer 71. The data wire (62, 63, 65a, 65b, 66a, 66b) includes a data line 62 extending in a longitudinal direction, intersecting the gate line 22, and defining pixels, a driving voltage line 63 supplying a driving voltage, a first source electrode 65a connected to the first source region 405a through a contact hole 75a as a branch of the data line 62, a first drain electrode 66a spaced apart from the first source electrode 65a and connected to the first drain region 406a, a second source electrode 65b connected to the second source region 405b through a contact hole 75b as a branch of the driving voltage line 63, and a second drain electrode 66b spaced apart from the second source electrode 65b and connected to the second drain region 406b. The first drain electrode 66a contacts the first drain region 406a and the second gate electrode 26b through contact holes 76a and 73 passing through the first interlayer insulating layer 71 and the gate insulating layer 30 and electrically connects them. The second drain electrode 66b is electrically connected with the second drain region 406b through the contact hole 76b passing through the first interlayer insulating layer 71 and the gate insulating layer 30.

Like the gate wire (22, 26a, 26b, 27), the data wire (62, 63, 65a, 65b, 66a, 66b) has a triple-layered structure including an underlying layer (621, 631, 651a, 651b, 661a, 661b) containing silver oxide, a silver conductive layer (622, 632, 652a, 652b, 662a, 662b) containing silver or a silver alloy, and an upper layer (623, 633, 653a, 653b, 663a, 663b), respectively.

The wire structure of FIG. 1 is applied to the multi-layered data wire (62, 63, 65a, 65b, 66a, 66b). For example, here, the underlying layer (621, 631, 651a, 651b, 661a, 661b) complements adhesion between the silver conductive layer (622, 632, 652a, 652b, 662a, 662b) and a lower structure, that is, semiconductor layers 405a, 405b, 406a and 406b and the first interlayer insulating layer 71 and prevents materials forming the semiconductor layers 405a, 405b, 406a and 406b, the first interlayer insulating layer 71 and the silver conductive layers (622, 632, 652a, 652b, 662a, 662b) from being diffused into each other.

Here, the semiconductor layers 40a and 40b, the first and second gate electrodes 26a and 26b, the first and second source electrodes 65a and 65b, and the first and second drain electrodes 66a and 66b constitute first and second TFT transistors, respectively. The first TFT is a switching TFT and the second TFT is a driving TFT. In the illustrated embodiment, a top gate-type TFT is formed, including the gate electrodes 26a and 26b formed on the semiconductor layers 40a and 40b having the channel portions 402a and 402b.

A second interlayer insulating layer 72 made of silicon nitride, silicon oxide, or an organic insulating material is formed on the data wire (62, 63, 65a, 65b, 66a, 66b) and includes a contact hole 72b exposing the drain electrode 66b.

A pixel electrode 82 connected to the second drain electrode 66b through the contact hole 72b is formed on the second interlayer insulating layer 72. The pixel electrode 82 is preferably made of a high reflectivity material such as Al (or Al alloy) or Ag (or Ag alloy). When necessary, the pixel electrode 82 may be made of a transparent conductive material such as ITO or IZO. A material forming the pixel electrode 82 can be selected according to whether the display device is a bottom emission type in which a picture is displayed below the TFT substrate or a top emission type in which a picture is displayed above the TFT substrate.

A partition wall 91 made of an organic insulating material is formed on the second interlayer insulating layer 72 to separate organic light emitting cells. The partition wall 91 is formed by exposing and developing a photosensitive agent including a black pigment to serve as a blocking layer and simplify its formation process. An organic light emitting layer 92 is formed in a region on the pixel electrode 82 surrounded by the partition wall 91. The organic light emitting layer 92 is made of organic layers that emit one of red, green, and blue, and the red, green, and blue organic layers of the organic light emitting layer 92 are sequentially and repetitively arranged.

A buffer layer 95 is formed on the organic light emitting layer 92 and the partition wall 9l. The buffer layer 95 may not be formed if necessary.

A common electrode 100 is formed on the buffer layer 95. The common electrode 100 is made of a transparent conductive material such as ITO or IZO. When the pixel electrode 82 is made of a transparent conductive material such as ITO or IZO, the common electrode 100 may be made of a high reflectivity material such as silver (Al) or silver (Al) alloy.

The TFT substrate of FIGS. 12A through 12C can be applied to an organic EL display device.

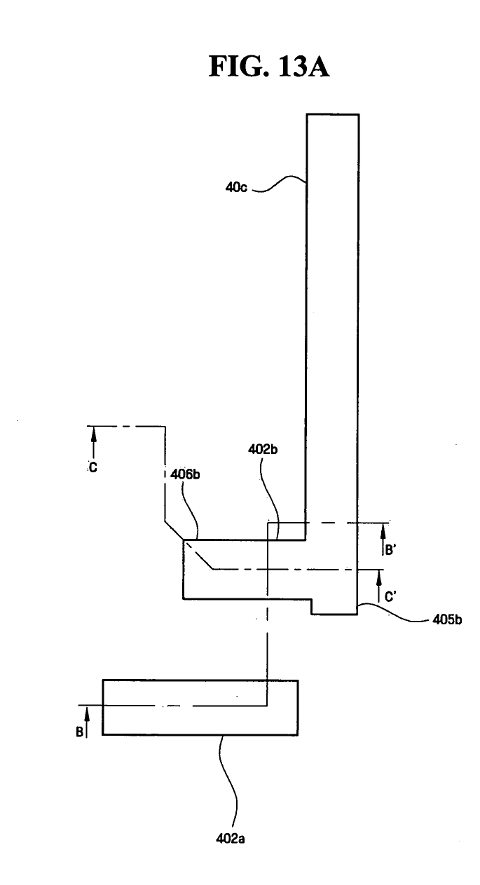

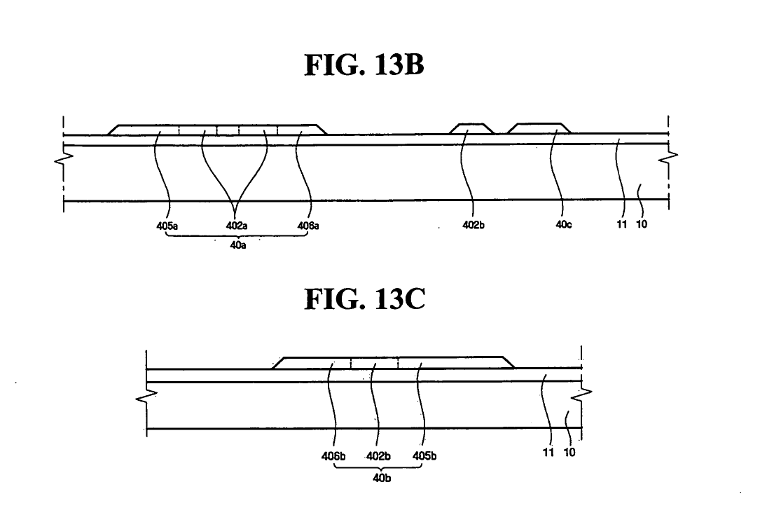

Next, a method for fabricating a TFT substrate according to another embodiment of the present invention will be described in detail with reference to FIGS. 13A through 13C.

Referring to FIGS. 13A through 13C, the blocking layer 11 is formed by depositing silicon oxide on the substrate 10 and amorphous silicon is deposited on the blocking layer 11 through low pressure chemical vapor deposition (LPCVD) or plasma enhanced chemical vapor deposition (PECVD) and is then patterned. Next, a laser is irradiated or heat is applied to the amorphous silicon to crystallize the amorphous silicon into polycrystalline silicon. Next, the semiconductor layers 40a, 40b, and 40c made of polycrystalline silicon are formed.

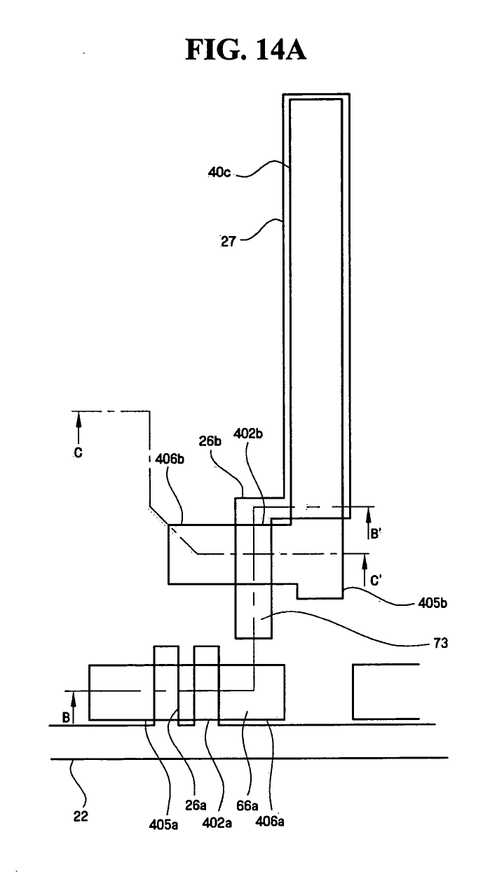

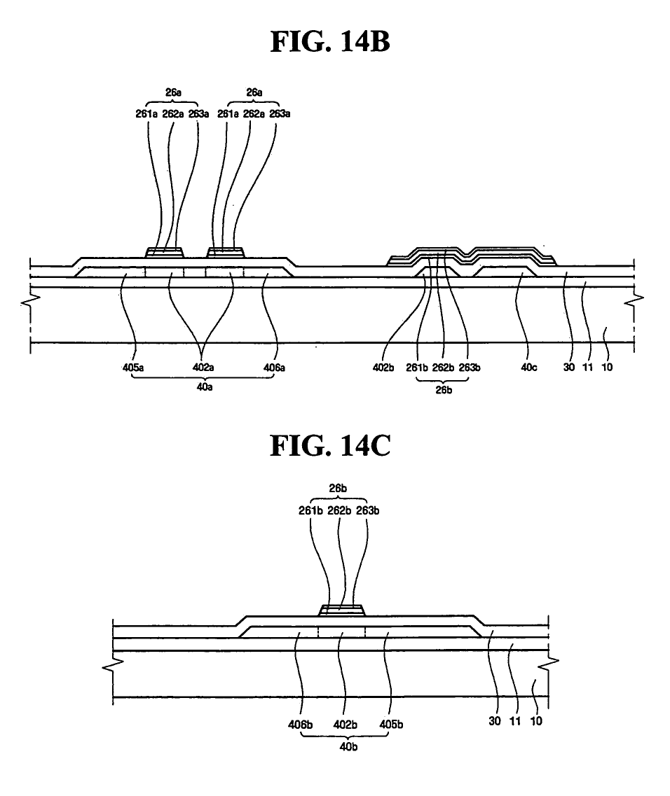

Referring to FIGS. 14A through 14C, the gate insulating layer 30 is formed on the blocking layer 11 where the semiconductor layers 40a, 40b, and 40c are formed, by depositing silicon nitride using CVD.

The multi-layered gate layer is formed by sequentially depositing the underlying layer (261a, 261b, 271) containing silver oxide, the silver conductive layer (262a, 262b, 272) containing silver (Ag) or a silver (Ag) alloy, and the upper layer (263a, 263b, 273) on the gate insulating layer 30 by sputtering.

Next, the first photoresist pattern defining the first gate electrode 26a and the gate line 22 is formed on the multi-layered gate layer. A region where the second gate electrode 26b and the storage electrode 27 are to be formed is covered and protected, including the channel portion 402a of the second TFT. Next, the upper layer 263a, the silver conductive layer 262a, and the underlying layer 261 a are sequentially etched or etched in a batch process using the first photoresist pattern as an etching mask.

The channel portion 402a under the first gate electrode 26a is defined by injecting n-type impurity ions in the semiconductor layer 40a of the first TFT portions and the first source region 405a and the first drain region 406a are formed. Next, the first photoresist pattern is removed. In this way, the gate line 22, the first gate electrode 26a, and the semiconductor layer 40a are completed, the semiconductor layer 40a including the channel portion 402a, the first source region 405a and the first drain region 406a.

The gate wire (22, 26a, 26b, 27) can be formed by the same method used for forming the wire structure of FIG. 1. Thus, as described above with reference to FIG. 4, the completed gate wire (22, 26a, 26b, 27) including the silver conductive layer (262a, 262b, 272) can be well adhered to a lower structure, e.g., the gate insulating substrate 30, even after wet etching and removing photoresist.

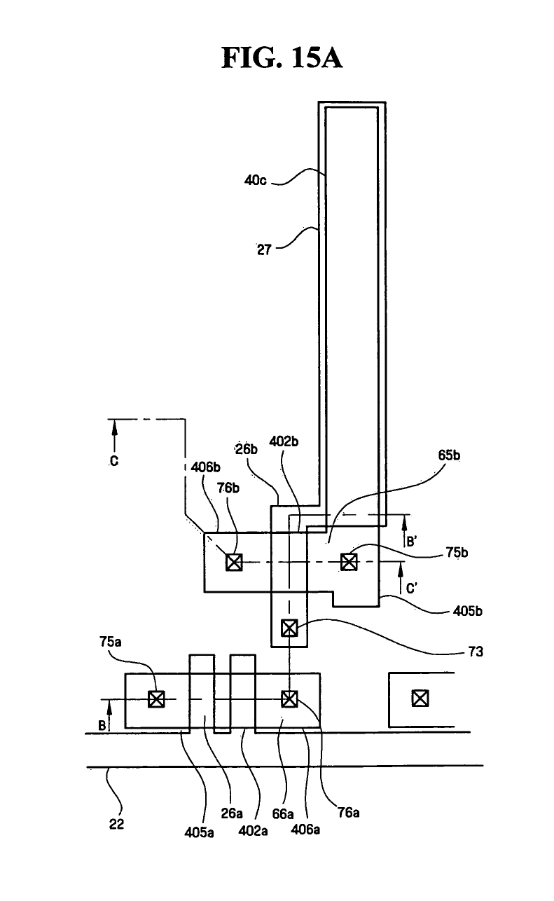

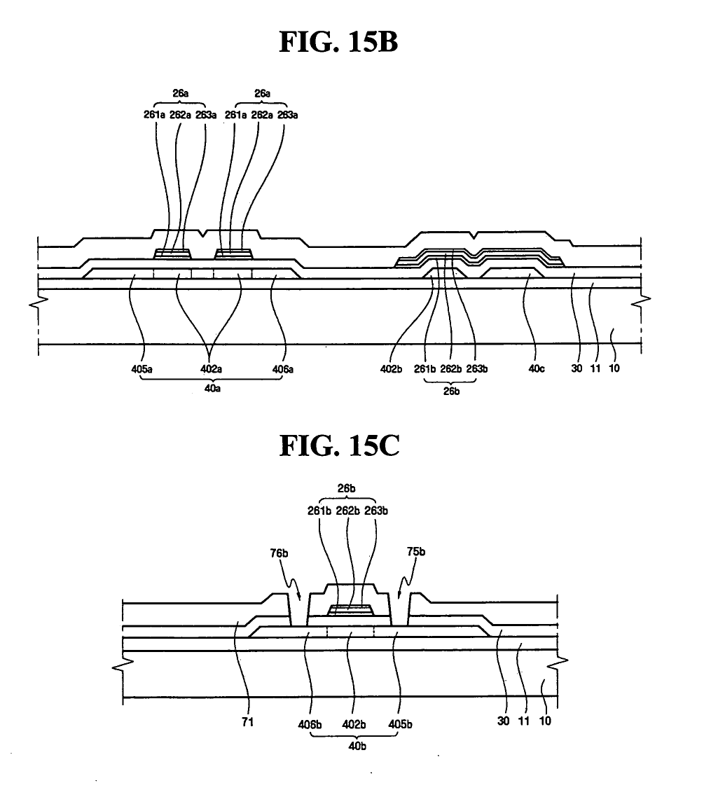

Referring to FIGS. 15A through 15C, the first interlayer insulating layer 71 is deposited on the gate insulating layer 30 where the gate wire (22, 26a, 26b, 27) is formed and photolithography is performed on the first interlayer insulating layer 71 and the gate insulating layer 30, thereby forming the contact holes 75a, 76a, 75b and 76b exposing the first source region 405a, the first drain region 406a, the second source region 405b, and the second drain region 406b and the contact hole 73 exposing a portion of the second gate electrode 26b, respectively.

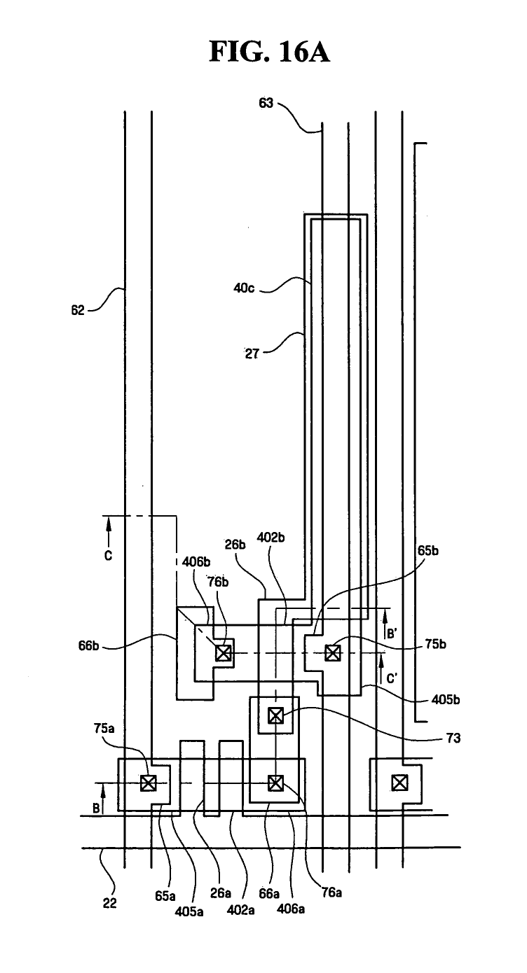

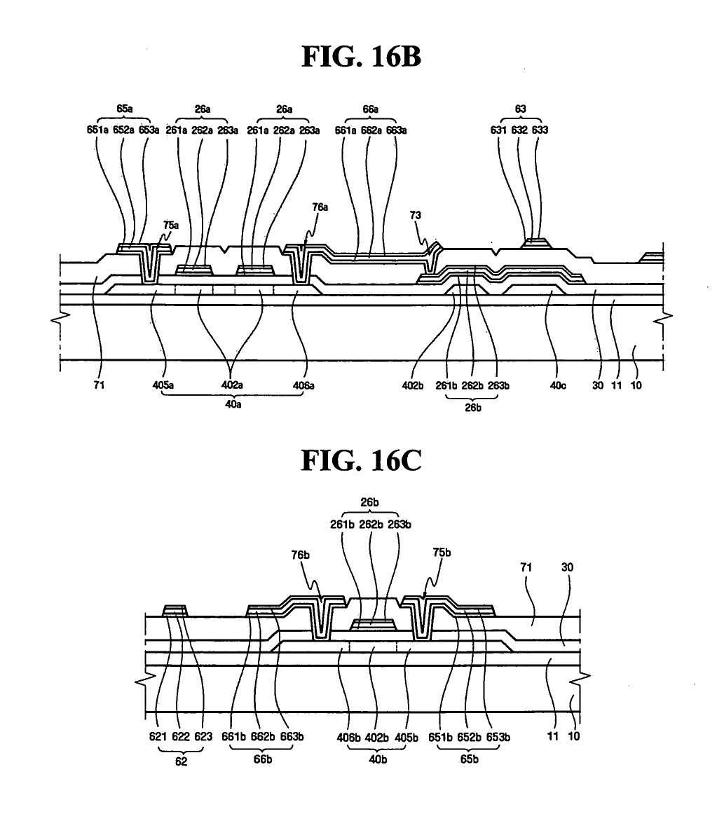

Referring to FIGS. 16A through 16C, a multi-layered data layer is formed by sequentially depositing the underlying layer (621, 631, 651a, 651b, 661a, 661b) containing silver oxide, the silver conductive layer (622, 632, 652a, 652b, 662a, 662b) containing silver or a silver alloy, and the upper layer (623, 633, 653a, 653b, 663a, 663b) on the semiconductor layers 40a and 40b exposed by the first interlayer insulating layer 71 and the contact holes 75a, 76a, 75b, and 76b by sputtering. Next, the photoresist pattern defining the data wire (62, 63, 65a, 65b, 66a, 66b) is formed on the multi-layered data layer and the upper layer (623, 633, 653a, 653b, 663a, 663b), the silver conductive layer (622, 632, 652a, 652b, 662a, 662b), and the underlying layer (621, 631, 651a, 651b, 661a, 661b) are sequentially etched or etched in a batch process using the photoresist pattern as an etching mask. The data wire is thus completed, the data wire including the data line 62 extending in a longitudinal direction, intersecting the gate line 22 to define a pixel, the driving voltage line 63 supplying a driving voltage, the first source electrode 65a connected to the first source region 405a through the contact hole 75a as a branch of the data line 62, the first drain electrode 66a spaced apart from the first source electrode 65a and connected to the first drain region 406a, the second source electrode 65b connected to the second source region 406a through the contact hole 75b as a branch of the driving voltage line 63, and the second drain electrode 66b spaced apart from the second source electrode 65b and connected to the second drain region 406b.

The wire structure of FIG. 1 can be applied to the data wire (62, 63, 65a, 65b, 66a, 66b). Therefore, as described with reference to FIG. 4, the formed data wire (62, 63, 65a, 65b, 66a, 66b) including the silver conductive layer (622, 632, 652a, 652b, 662a, 662b), is well adhered to a lower structure, e.g., the semiconductor layers 40a and 40b, even after a patterning process such as wet etching or removing photoresist. Thus, a top gate-type first TFT is formed, including the semiconductor layer 40a, the gate electrode 26a formed thereon, the source electrode 65a, and the drain electrode 66a where the gate electrode 26a is formed on the semiconductor layer 40a, and a top gate-type second TFT is formed, including the semiconductor layer 40b, the gate electrode 26b formed thereon, the source electrode 65b, and the drain electrode 66b where the gate electrode 26b is formed on the semiconductor layer 40b.

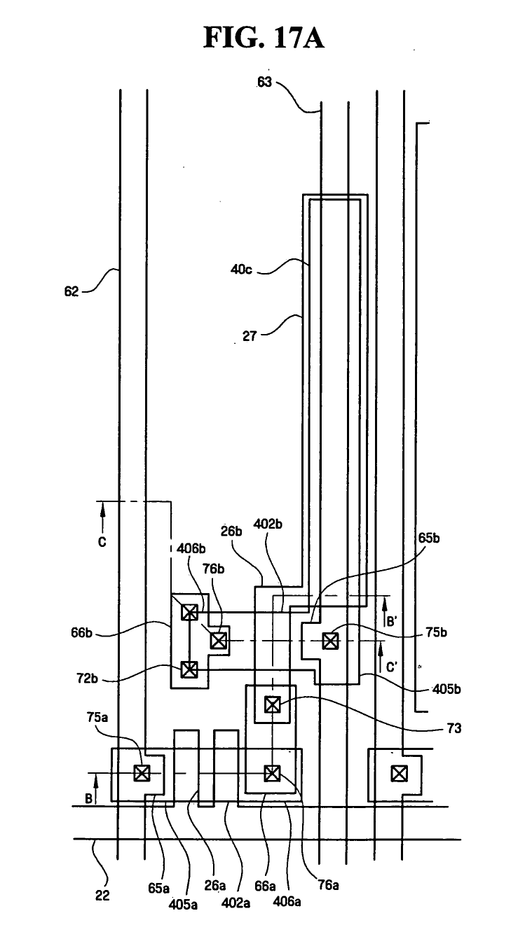

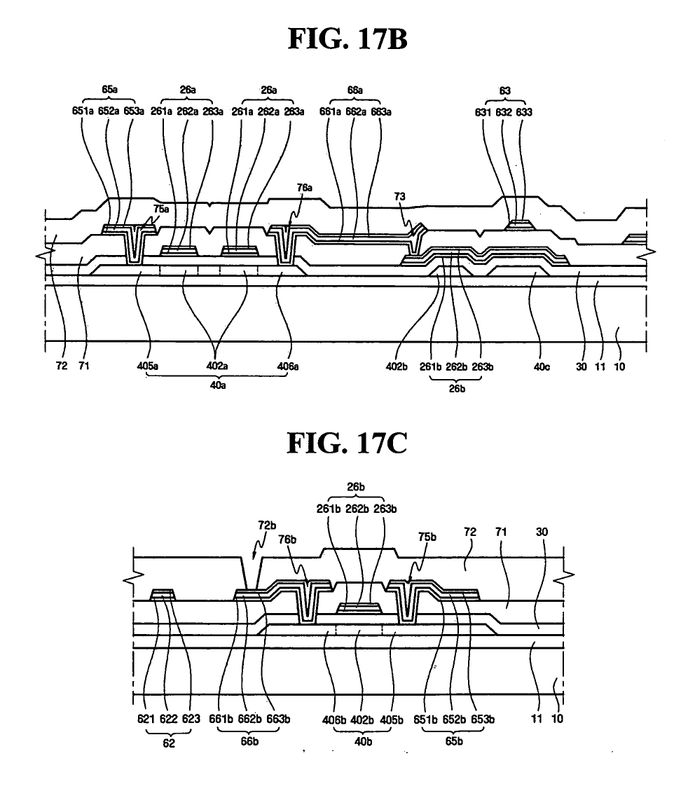

Next, as shown in FIGS. 17A through 17C, the second interlayer insulating layer 72 is deposited and patterned, thereby forming the contact hole 72b exposing the second drain electrode 66b.

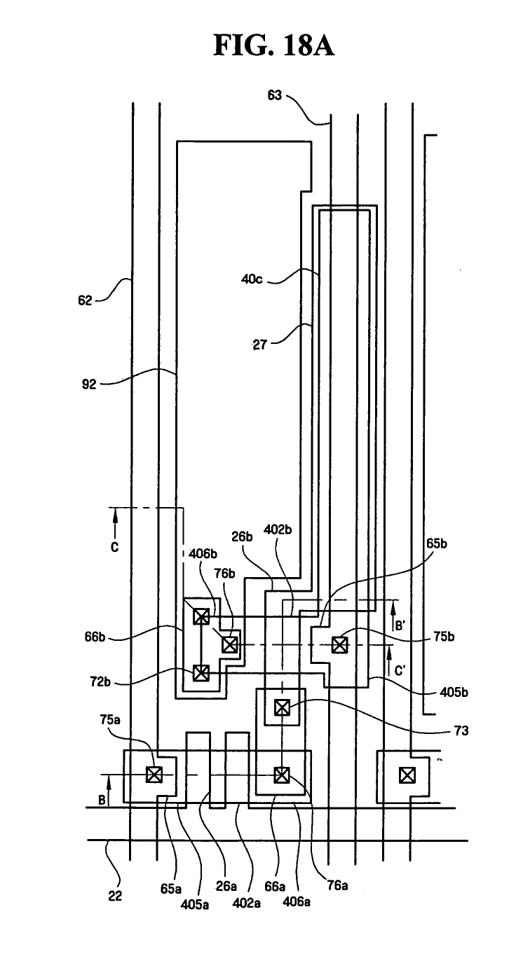

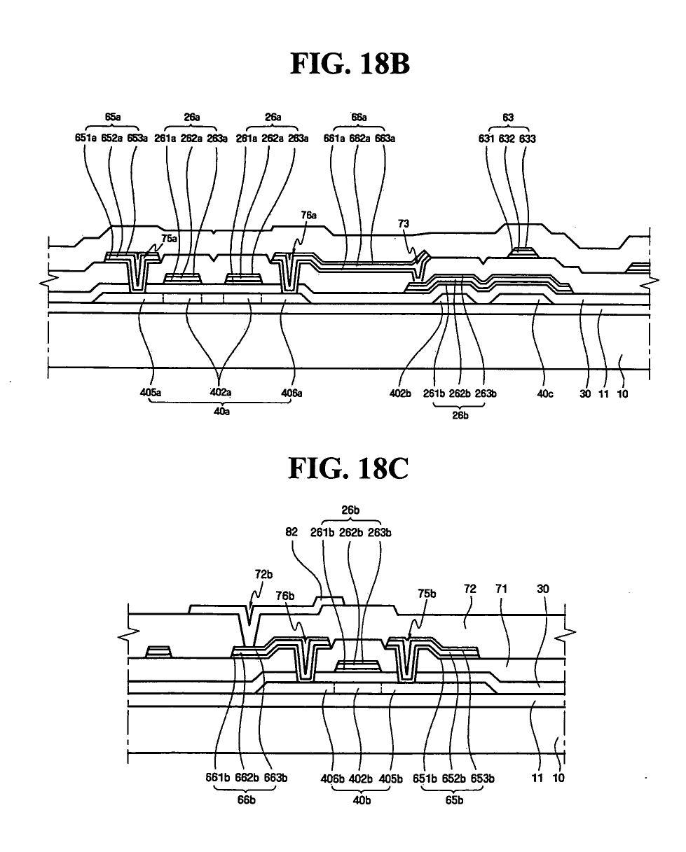

Next, as shown in FIGS. 18A through 18C, a metal having superior reflectivity such as aluminum (or an aluminum alloy) or silver (or a silver alloy) is deposited and patterned, thereby forming the pixel electrode 82.

Next, referring back to FIGS. 12A through 12C, an organic layer including a black pigment is coated on the second interlayer insulating layer 72 where the pixel electrode 82 is formed and is then exposed and developed, thereby forming the partition wall 91 filling a region except for an organic light emitting space. Next, the organic light emitting layer 92 is formed in the organic light emitting space using deposition or inkjet printing.

Next, a conductive organic material is coated on the partition wall 91 and the organic light emitting layer 92, thereby forming the buffer layer 95. ITO or IZO is deposited on the buffer layer 95, thereby forming the common electrode 100. Here, the pixel electrode 82 is preferably made of a transparent conductive material such as ITO or IZO. In this case, the common electrode 100 may be made of made of a high reflectivity material such as Al (or Al alloy) or Ag (or Ag alloy).

While a triple-layered wire structure according to an embodiment of the present invention comprising an underlying layer containing silver oxide in gate and data lines, a silver conductive layer containing silver or a silver alloy, and a upper layer, has been described, it is to be understood that in some embodiments only one of the gate and data lines may have the triple-layered wire structure while the other line may have a wire structure that is well known in the art.

Further, while the TFT substrate according to an embodiment of the present invention and the fabrication method thereof have been described as being applied to a bottom gate-type LCD, the TFT substrate and fabrication method thereof can also be applied to an organic EL display. In this case, a pair of bottom gate-type TFTs is provided for each pixel as a switching TFT and a driving TFT, respectively.

In addition, although the TFT substrate according to another embodiment of the present invention and the fabrication method thereof have been described as being applied to a top gate-type organic EL display, the TFT substrate and fabrication method thereof can also be applied to a TFT substrate for an LCD having a TFT for each pixel. In this case, the top gate-type TFT LCD is preferably a reflective type. Further, the TFT substrate according to an embodiment of the present invention and the fabrication method thereof can also be applied to an array on color filter (AOC) substrate having thin film transistors on a color filter.

As described above, in a wire structure and a method for fabricating a wire according to an embodiment of the present invention, since adhesion between a silver conductive layer and a lower structure is improved, a reliable, low-resistivity silver wire having improved signal characteristics can be attained. Further, since the wire fabrication method is simplified, processing efficiency can also be improved.

While the present invention has been particularly illustrated and described with reference to exemplary embodiments thereof, it will be understood by those of ordinary skill in the art that various changes in form and details may be made therein without departing from the spirit and scope of the present invention as defined by the following claims.

What is claimed is:

1. A wire structure, comprising:
an underlying layer including sliver oxide formed on a lower structure; and
a silver conductive layer including silver or a silver alloy formed on the underlying layer.

2. The wire structure of claim 1, wherein the silver oxide is positioned at an interface between the lower structure and the underlying layer.

3. The wire structure of claim 1, wherein a thickness of the underlying layer is in a range of about 10-about 2000 Å.

4. The wire structure of claim 1, wherein the underlying layer includes about 5-about 60 at % of oxygen.

5. The wire structure of claim 1, further comprising an upper layer including silver oxide formed on the silver conductive layer.

6. The wire structure of claim 1, further comprising an upper layer including indium tin oxide (ITO), amorphous ITO, indium zinc oxide (IZO), tungsten (W), molybdenum (Mo), molybdenum-niobium (MoNb), or molybdenum-tungsten (MoW) formed on the silver conductive layer.

7. The wire structure of claim 1, wherein the lower structure is an insulating substrate, a semiconductor layer, or an insulating layer.

8. A method for fabricating a wire, the method comprising:
forming an underlying layer including silver oxide on a lower structure;
forming a silver conductive layer including silver or a silver alloy on the underlying layer;
forming an upper layer on the silver conductive layer; and
patterning the upper layer, the silver conductive layer, and the underlying layer using a photoresist pattern defining the wire using an etching mask.

9. The method of claim 8, wherein forming the underlying layer comprises positioning the silver oxide at an interface between the lower structure and the underlying layer.

10. The method of claim 8, wherein forming the underlying layer comprises performing sputtering in an atmosphere including oxygen using silver or a silver alloy as a target.

11. The method of claim 10, wherein forming the silver conductive layer is performed after forming the underlying layer while a supply of oxygen gas is interrupted.

12. The method of claim 8, wherein the upper layer includes silver oxide.

13. The method of claim 12, wherein forming the upper layer is performed after forming the silver conductive layer while supplying oxygen.

14. The method of claim 8, wherein the underlying layer includes about 5-about 60 at % of oxygen.

15. The method of claim 8, wherein the lower structure is an insulating substrate, a semiconductor layer, or an insulating layer.

16. A thin film transistor (TFT) substrate, comprising:
a gate wire formed on an insulating substrate and including a gate line extending in a first direction and a gate electrode connected to the gate line; and
a data wire formed on the insulating substrate insulated from the gate wire and including a data line extending in a second direction and intersecting the gate line, a source electrode connected to the data line, and a drain electrode spaced apart from the source electrode on the insulating substrate,
wherein the gate wire or the data wire each comprise:
an underlying layer including silver oxide formed on a lower structure; and
a silver conductive layer including silver or a silver alloy formed on the underlying layer.

17. The thin film transistor (TFT) substrate of claim 16, wherein the silver oxide is positioned at an interface between the lower structure and the underlying layer.

18. The thin film transistor (TFT) substrate of claim 16, wherein a thickness of the underlying layer is in a range of about 10-about 2000 Å.

19. The thin film transistor (TFT) substrate of claim 16, wherein the underlying layer includes about 5-about 60 at % of oxygen.

20. The thin film transistor (TFT) substrate of claim 16, further comprising an upper layer including silver oxide formed on the silver conductive layer.

21. The thin film transistor (TFT) substrate of claim 16, further comprising an upper layer including indium tin oxide (ITO), amorphous ITO, indium zinc oxide (IZO), tungsten (W), molybdenum (Mo), molybdenum-niobium (MoNb), or molybdenum-tungsten (MoW) formed on the silver conductive layer.

22. A method for fabricating a thin film transistor (TFT) substrate, the method comprising:
forming a gate wire on an insulating substrate including a gate line extending in a first direction and a gate electrode connected to the gate line; and
forming a data wire on the insulating substrate insulated from the gate wire and including a data line extending in a second direction and intersecting the gate line, a source electrode connected to the data line, and a drain electrode spaced apart from the source electrode on the insulating substrate,
wherein forming the gate wire or the data wire comprises:
forming an underlying layer including silver oxide on a lower structure;
forming a silver conductive layer including silver or a silver alloy on the underlying layer;
forming an upper layer on the silver conductive layer; and
patterning the upper layer, the silver conductive layer and the underlying layer using a photoresist pattern defining the wire as an etching mask.

23. The method of claim 22, wherein forming the underlying layer comprises positioning the silver oxide at an interface between the lower structure and the underlying layer.

24. The method of claim 22, wherein forming the underlying layer comprises performing sputtering in an atmosphere including oxygen using silver or a silver alloy as a target.

25. The method of claim 24, wherein forming the silver conductive layer is performed after forming the underlying layer while a supply of oxygen gas is interrupted.

26. The method of claim 22, wherein the upper layer includes silver oxide.

27. The method of claim 26, wherein forming the upper layer is performed after forming the silver conductive layer while supplying oxygen.

28. The method of claim 22, wherein the lower structure includes about 5-about 60 at % of oxygen.
